(19) United States
(12) Patent Application Publication
(10) Pub. No.: US 2022/0220987 A1
(43) Pub. Date: Jul. 14, 2022

(54) PROTECTIVE TUBE FOR INSERTION INTO A PIPE OR VESSEL WITH REDUCED SENSITIVITY TO VORTEX INDUCED VIBRATIONS

(71) Applicant: Endress+Hauser Wetzer GmbH+Co. KG, Nesselwang (DE)

(72) Inventor: Massimo Del Bianco, Monza (IT)

(21) Appl. No.: 17/569,069

(22) Filed: Jan. 5, 2022

(30) Foreign Application Priority Data
Jan. 8, 2021 (EP) 21150706.6

(51) Int. Cl. F15D 1/10; F16L 55/07; G01K 1/08; G01K 13/02; B23K 31/02

(52) U.S. Cl. CPC F15D 1/10; F16L 55/07; G01F 1/46; G01K 13/02; B23K 31/027; G01K 1/08

(57) ABSTRACT

The present disclosure includes a method of producing a protective tube for insertion into a pipe or vessel containing a medium, the protective tube including a tubular member having a bore extending between an upper and lower of the tubular member, wherein the method includes the steps of providing a preformed element comprising a coiled wire with at least one turn, arranging the preformed element around an outer surface of the tubular member, and welding the preformed element on an outer surface of the tubular member.

The present application is related to and claims the priority benefit of European Patent Application No. 21150706.6, filed on Jan. 8, 2021, the entire contents of which are incorporated herein by reference.

### TECHNICAL FIELD

The present disclosure pertains to a method of producing a protective tube for insertion into a pipe or vessel containing a medium.

### BACKGROUND

Protective tubes in the field of measuring inserts for determining and/or monitoring a process variable of a medium are, e.g., known in the form of thermowells for thermometers which serve for determining and/or monitoring the temperature of a medium. The measuring insert of a thermometer usually at least includes one temperature sensor for determining and/or monitoring the temperature of the medium. The temperature sensor in turn includes at least one temperature-sensitive component, e.g., in the form of a resistive element, commonly a platinum element, or in the form of a thermocouple. However, protective tubes are also known in connection with gas sampling probes, where a gas sample is, often dynamically, taken out from a pipe or vessel. The present disclosure thus generally relates to fluid processing and related measurements employing insertion type probe bodies and is not restricted to thermowells or gas sampling probes.

Such protective tubes are frequently exposed to the flow of the respective medium, which causes different mechanical forces acting on the protective tube, e.g., shear forces or forces induced by coherent vortex shedding and which can result in vortex induced vibrations (VIV). Vortex shedding in fluid dynamics is known as a “Kaman vortex street” and refers to a repeating pattern of swirling vortices in alternating directions caused by the unsteady separation of flow of a medium around a body, causing said body to vibrate. The closer the frequency of the vibrations is to the natural frequency of the body around which the medium flows, the more the body vibrates. The frequency of the vibrations is, e.g., determined by several process parameters, such as the physical properties of the medium, the flow velocity and the shape of the body.

Due to the high risk of damage of protective tubes subject to VIV, these vibrations, e.g., need to be duly considered during production. For example, in the case of thermometers, standard methods, such as ASME PTC 19.3 TW-2000, are available, which define several design rules that help to reduce negative effects of coherent vortex shedding. The basic principle underlying the design rules is to increase the natural frequency of vibrations of the thermometer to separate the natural frequency from the vortex shedding frequency. In such way, the dangerous condition of resonant vortex induced vibrations becomes minimized. For this purpose, commonly the geometry of the thermometer is varied, e.g., by reducing its length and/or by increasing its diameter.

Alternatively, when functional constraints do not allow certain changes in the dimensions of the thermometer, mechanical supports or absorbers are frequently used to reduce the thermometer's sensitivity to vortex shedding. These mechanical supports or absorbers are usually fitted into a gap between the opening of the vessel or pipe and the outside surface of the thermometer. The supports or absorbers then increase the natural frequency of the thermometer by reducing the free length of the thermometer. However, it proves difficult to fit the supports or absorbers in such a way that a high level of coupling and therefore the desired effect can be achieved.

Yet, another approach to reduce VIV of protective tubes is to provide certain structures or structural elements on the protective tube. In this context, helical fins on the outer surface of the protective tube have been proven very successful, e.g., as described in U.S. Pat. Nos. 3,076,533A, 4,991,976, 7,424,396B2, 653,931B1, 7,836,780B2, US2013/0142216A1, GB2442488A or WO2020/035402A1 for different configurations.

### SUMMARY

Based on these approaches the objective technical problem underlying the present disclosure to provide a method of producing such thermowell by a straightforward procedure. This problem is solved by means of the method of the present disclosure.

The method of producing a protective tube for insertion into a pipe or vessel containing a medium according to the present disclosure, wherein the protective tube has a tubular member having a bore extending between an upper and lower end of the tubular member, comprises the steps of:

providing a preformed element comprising a coiled wire with at least one turn;

arranging the preformed element around an outer surface of the tubular member; and

welding the preformed element on an outer surface of the tubular member.

The preformed element preferably has a screw or coil-like form with at least one helical winding. The protective tube is, e.g., made of a metal, like stainless or carbon steel, or a nickel alloy. It is of advantage if the preformed element is made from the same material as the protective tube.

The protective tube is usually mounted on the pipe or vessel via an opening which may have a process connection for connecting the protective tube to the vessel or pipe. The protective tube at least partially extends into an inner volume of the vessel or pipe and is at least partially in contact with the flowing medium. The protective tube may be arranged such that its longitudinal axis proceeds perpendicular to the flow direction of the medium. However, also angles between the longitudinal axis and the flow direction different from 90° can be employed.

In the state of the art, protective tubes with at least one helical structure are typically produced by a machining process or by welding a wire onto the outer surface of the tubular member, both being comparably elaborate procedures. According to the present disclosure, on the other hand, a preformed element is provided, which can be easily mounted and to the outer surface of the tubular member. Such procedure further has the advantages that it is cheap and that retrofitting of existing protective tubes to reduce their sensitivity to vortex shedding becomes possible in an easy and straightforward manner.

In an embodiment, the preformed element is embodied and/or arranged such, that after welding onto the tubular member, it forms at least one helical fin, winding around the outer surface of the tubular member and defining a flow channel along at least a part of the tubular member.

In this regard, it is of advantage if at least one geometrical parameter of the at least one helical fin is chosen such that it depends on at least one process condition of the medium in the vessel or pipe, in particular at least one of a flow profile, a flow velocity, a pressure, a temperature, a density or a viscosity of the medium, a diameter, a volume or a roughness of the pipe or vessel, or a length or diameter of the tubular member. In this regard, reference is made to the yet unpublished European patent application with file reference EP 20195284.3, the content of which is fully incorporated by reference.

Choosing geometrical parameters of the helical fin enables to provide a protective tube with at least one customized helical fin that is chosen in dependence of the specific applied process. The geometrical parameter is at least one parameter defining the form and/or shape of the flow channel and/or the at least one helical fin, e.g., a height, a pitch, a width, a depth or a shape of the at least one helical fin, or a cross-sectional area of the flow channel. All these medium and pipe/vessel related parameters do have an impact on VIV. The geometrical parameters characterizing the helical fins are functions of the process conditions.

Preferably, a pitch of the helical fin is in the range of 1-4 times a diameter of the wire of the preformed element.

The protective tube can be used in a wide range of applications and can, e.g., be part of a gas sampling probe with an inlet and outlet end or a Pitot tube. However, in at least one embodiment, the protective tube is closed at one end section to form a protective tube in the form of a thermowell. In such case, the protective tube may serve for receiving a measuring insert for determining and/or monitoring a process variable of a medium, e.g., the temperature of the medium. The measuring insert in turn preferably has a rod-like form and may be inserted into the bore of the tubular member.

For producing the weld between the tubular member and the preformed element, several options are available which all fall under the scope of protection of the present disclosure. Several embodiments are described in the following:

In an embodiment, a weld is produced in an upper and lower end section of the preformed element. In this embodiment, only two welds are needed to mount the preformed element on the tubular member.

In another embodiment, at least one weld is produced in a center area of the preformed element. Such additional weld can yield in a reinforcement of the connection between the tubular member and the preformed element. This is of particular advantage in case of comparably long tubular members and long preformed elements.

At least one embodiment comprises that the weld is produced along one turn of the preformed element. For example, in an embodiment having two welds in the lower and upper end sections of the tubular member, the preformed element is welded in an area given by the first and last turn of the coiled wire. By such procedure, a circular weld can be produced.

At least one embodiment comprises that an upper and/or lower end section of the preformed element are embodied in the form of a ring, and wherein a coiled section is arranged between the upper and lower end section. The preformed element thus closes with a ring section.

In this regard, it is of advantage if the weld is produced in the area of a ring. This embodiment thus also enables to produce a circular weld.

All the described embodiments relating to production of the weld advantageously do not necessitate a continuous weld along the entire preformed element.

Another embodiment of the inventive method comprises that a cross-sectional area of the preformed element has the form of a circle, an ellipse or a square. Further, an embodiment comprises that a diameter of the wire of the preformed element is in the range of 5-20% of a diameter of the tubular member.

### BRIEF DESCRIPTION OF THE DRAWINGS

The present disclosure will now be explained in more detail by means of the following figures in which:

FIG. 1 illustrates vortex shedding for an insertion body exposed to a flowing medium;

FIG. 2a shows a partial cut-away view of a thermometer having a state of the art thermowell;

FIG. 2b shows a cross-sectional view at line A-A of the thermowell of FIG. 2a;

FIG. 2c shows a side view of the thermometer of FIG. 2a with a fastening unit;

FIG. 3a shows a thermowell having a plurality of helical fins according to the state of the art forming a plurality of flow channels;

FIG. 3b shows flow channels for avoiding vortex induced vibrations;

FIGS. 4a-4d illustrate the influence of the flow profile and installation position along a pipe on the occurrence of vortex induced vibrations;

FIG. 5 shows a first embodiment of a protective tube in the form of a thermowell produced by the method according to the present disclosure; and

FIG. 6 shows a second embodiment of a protective tube in the form of a thermowell produced by the method according to the present disclosure.

In the figures, the same elements are always provided with the same reference symbols.

### DETAILED DESCRIPTION

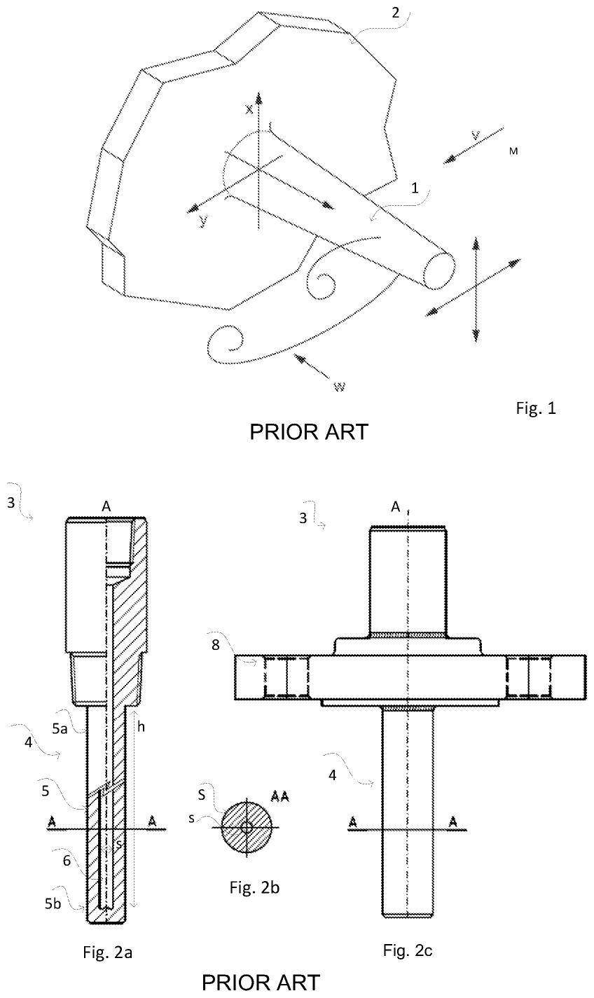

FIG. 1 illustrates the origin of vortex shedding w at a cylindrical, conically tapered protective tube 1 exposed to a flowing medium M in a pipe 2, which is represented by one of its walls. Downstream of the protective tube 1 in the flow direction v of the medium, a ridge-like pattern develops. Depending on the flow velocity v of the medium M, this can lead to coherent vortex shedding, which in turn may cause the protective tube 1 to vibrate.

Such vibrations are mainly due to two forces acting on the protective tube 1, a shear force in the y-direction and a lifting force in the x-direction. The shear force causes oscillations at a frequency fₛ, while the lifting force causes oscillates at a frequency of 2fₛ. The frequency fₛ now depends on the flow velocity v of the medium M, and on various physical or chemical medium properties such as its viscosity and density, as well as on the dimensions of the protective tube 1, such as its diameter and length. The closer the frequency fₛ is to the natural frequency of the protective tube 1 and the higher the flow velocity v of the medium M, the greater are the resulting oscillation causing forces.

As a result of the vibration causing forces, the protective tube 1 can be damaged or even break down completely. This is known as the so-called resonance condition.

FIG. 2a exemplarily and without limitation to such embodiment shows a state of the art thermometer 3 having a protective tube 1 in the form of a thermowell 4. As can be seen in FIG. 2a, the thermowell 4 comprises a tubular member 5 having a first end section 5a and a second end section 5b with a closed end. The tubular member 5 further includes a bore 6 forming a hollow space within the tubular member 5, which is defined by an inner surface s and a predeterminable height h parallel to a longitudinal axis A of the tubular member 5, which bore 6 serves for receiving a measuring insert (not shown) for determining and/or monitoring the process variable, e.g., the temperature of the medium M.

Further, as illustrated in FIG. 2c, a fastening unit 8 is provided, which exemplarily is attached to the tubular member 5 as shown. The fastening unit 8 may be a process connection and serves for mounting the thermowell 4 to the pipe 2 (not shown) such that the tubular member 5 at least partially extends into an inner volume of pipe 2 and such that it is at least partially in contact with the flowing medium M.

The outer surface S the thermowell 4 may have an essentially round shape as shown in FIG. 2b. However, such construction can easily lead to undesired vortex induced vibrations (VIV) of the thermometer 3.

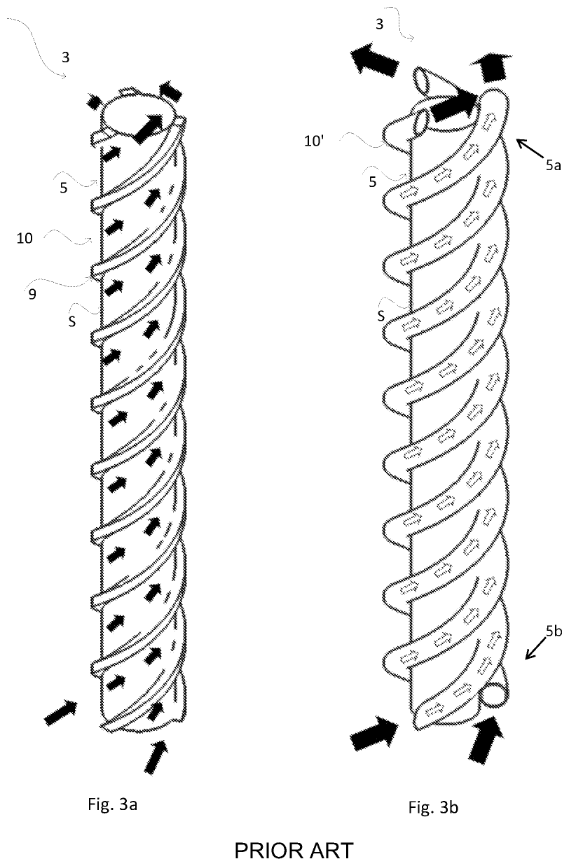

To overcome the problems associated with coherent vortex shedding, protective tubes 1 with helical fins 9, which are typically arranged on the outer cross-sectional surface S of the thermometer 3, have been suggested. An exemplarily thermometer 3 having three such helical fins 9 is shown in FIG. 3a. The helical fins 9 form flow channels 10 along the tubular member 5 and thereby reduce VIV of the protective tube 1. Each flow channel 10 is formed by the volume between two adjacent helical fins 9, which proceed around the tubular member 5 along its length axis A.

In certain embodiments, such flow channels 10 may be closed channels 10′, as illustrated in FIG. 3b. Such closed channels 10′ may be configured to carry medium M from the closed end section 5b towards the first end section 5a creating a suction mechanism for converting kinetic energy of the medium into pressure variations. Such variation in the flow velocity and pressure distribution would create a multidimensional motion of the medium which allows for decreasing of even suppressing VIV on the thermometer 3. Accordingly, the effectiveness of avoiding VIV is strongly related to the construction of the helical fins 9. The more the final shape resembles the ideal construction of FIG. 3b, the better the performance with respect to VIV.

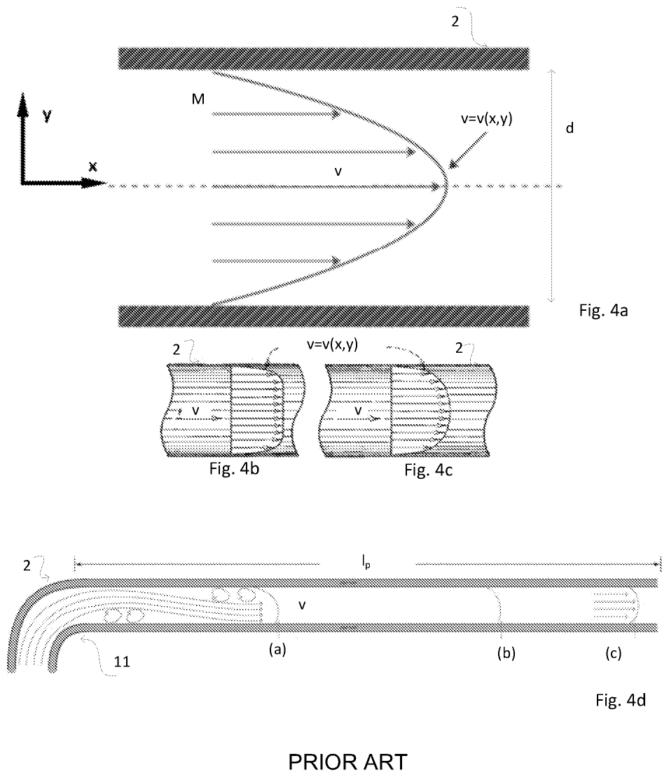

A second issue is the flow profile v(x,y) of the medium M in the pipe or vessel 2. Ideally, the flow profile v(x,y) for a circular pipe has a parabolic shape, as illustrated in FIG. 4a. Accordingly, the medium M has the highest relative velocity vᵣₑₗ within the center region of the pipe or vessel 2. The profile slightly varies depending on the length lₚ of the pipe or vessel 2, as illustrated for the case of a comparably short pipe sections 2 in FIG. 4b and a comparably long pipe section 2 for FIG. 4c.

Additionally, the installation position and/or the presence of flow modifying elements, e.g., like the pipe corner piece 11 shown in FIG. 4d, within a pipe/vessel 2 system may be considered as they also strongly influence the flow profile. After passing the pipe corner piece, the flow profile v(x,y) is asymmetrical (a) and only slowly transforms through several transition areas (b) to a symmetrical profile (c) in a straight pipe 2 section following the pipe corner piece 11.

The present disclosure now provides a method for producing a protective tube employing a helical structure on an outer surface of a tubular member of the protective tube in a straightforward manner. In the following, three especially preferred embodiments of thermowells produced by an inventive method, are shown. The present disclosure is, however, not limited to protective tubes in the form of a thermowell but rather is applicable to a wind range of protective tubes, in particular also to gas sampling probes and pitot tubes.

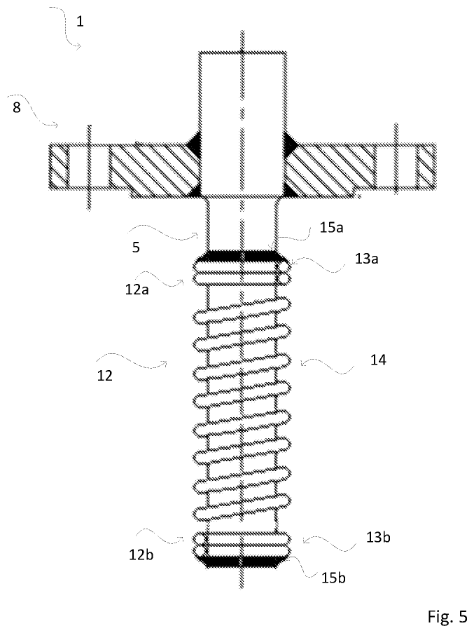

A thermowell produced according to a first preferred embodiment of the method according to the present disclosure is shown in FIG. 5. The protective tube 1 with fastening means 8 has a tubular member 5. Along a section of the tubular member 5 a preformed element 12 comprising a coiled wire with at least one turn is arranged. Note that other embodiments can also comprise arranging of the preformed element along the entire length of the tubular member 5.

The preformed element 12 shown in FIG. 5 is provided with a first ring 13a in its upper end section 12a and a second ring 13b in the second end section 12b. Between the two rings 13a, 13b a coiled section 14 is provided. The preformed element 12 is welded to the tubular member 5 by means of two welds 15a, 15b produced in the area of the rings 13a, 13b.

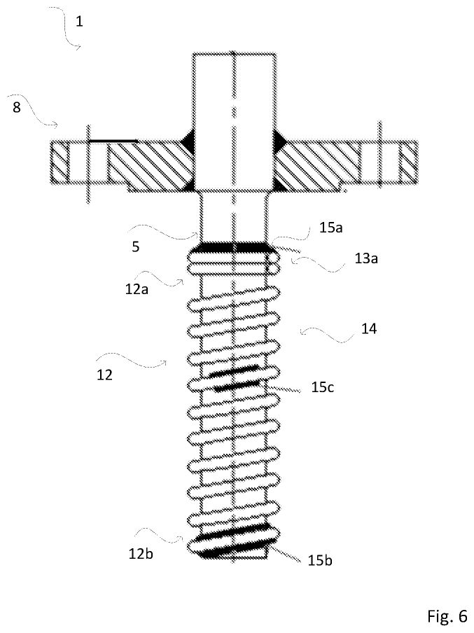

A second preferred embodiment is subject to FIG. 6. In contrast to the protective tube 1 shown in FIG. 5, in the embodiment of FIG. 6, the preformed element 12 has only one ring 13a in the upper end section 12a, in which a first weld 15a is produced. In the lower end section 12b, a second weld 15b is produced along one turn of the preformed element 12, here the last turn of the preformed element 12. A third weld 15c is produced in a center area of the preformed element 12. Such weld 15c serves for reinforcement of the connection between the preformed element 12 and the tubular member 5. It shall be noted, that such additional weld 15c is optional. Also, further embodiments may comprise no rings 13a,13b employed in the end sections 12a, 12b of the tubular member. Rather, any of the embodiments shown and also described previously can be combined with another.

Claimed is:

1. A method of producing a protective tube configured for insertion into a pipe or vessel containing a medium, the method comprising:
providing a protective tube comprising a tubular member including a bore extending between a first end and a lower end within the tubular member;
providing a preformed element comprising a coiled wire having at least one turn;
arranging the preformed element around an outer surface of the tubular member; and
welding the preformed element onto the outer surface of the tubular member.

2. The method of claim 1, wherein the preformed element is configured and/or arranged such that, after the welding onto the tubular member, the preformed element forms at least one helical fin, winding around the outer surface of the tubular member and defining a flow channel along at least a part of the tubular member.

3. The method of claim 2, wherein at least one geometrical parameter of the at least one helical fin is selected as to depend on at least one process condition of the medium in the vessel or pipe.

4. The method of claim 3, wherein the at least one process condition is at least one of:
a flow profile, a flow velocity, a pressure, a temperature, a density or a viscosity of the medium;
a diameter, a volume or a roughness of the pipe or vessel; and
a length or diameter of the tubular member.

5. The method of claim 1, wherein the tubular member is closed at the first end or the second end such that the protective tube is configured as a thermowell.

6. The method of claim 1, wherein the welding generates a weld is produced in an upper and a lower end section of the preformed element.

7. The method of claim 1, wherein the welding generates at least one weld in a center section of the preformed element.

8. The method of claim 1, wherein the welding generates a weld along one turn of the at least one turn of the preformed element.

9. The method of claim 1, wherein an upper and/or lower end section of the preformed element are configured as a ring, and wherein a coiled section is disposed between the upper end section and the lower end section.

10. The method of claim 9, wherein the welding generates a weld at or near the ring.

11. The method of claim 1, wherein a cross-sectional area of the preformed element defines a circle, an ellipse or a square.

12. The method of claim 1, wherein a diameter of the wire of the preformed element is 5-20% of a diameter of the tubular member.
